(19) United States
(12) Patent Application Publication
(10) Pub. No.: US 2025/0305160 A1
(43) Pub. Date: Oct. 2, 2025

(54) MEMBRANE

(71) Applicant: JOHNSON MATTHEY HYDROGEN TECHNOLOGIES LIMITED, London (GB)

(72) Inventors: Monica GONZALEZ HERRERA, Reading Berkshire (GB); William David MCDONNELL, Reading Berkshire (GB); Chris ZALITIS, Reading Berkshire (GB)

(21) Appl. No.: 18/864,330

(22) PCT Filed: Jun. 27, 2023
(86) PCT No.: PCT/GB2023/051676

§ 371 Date: Nov. 8, 2024

(30) Foreign Application Priority Data
Jun. 29, 2022 (GB) 2209514.5

(51) Int. Cl. C25B 9/23; C25B 11/042; C25B 13/08

(52) U.S. Cl. CPC C25B 9/23; C25B 11/042; C25B 13/08

(57) ABSTRACT

An electrolyte membrane comprising a recombination catalyst layer. The membrane has a thickness of less than or equal to 100 μm and is a single coherent polymer film comprising a plurality of ion conducting polymer layers. The recombination catalyst layer comprises particles of an unsupported recombination catalyst dispersed in an ion conducting polymer and the layer has a thickness in the range of and including 5 to 30 μm. Catalyst coated membranes (CCMs) incorporating the electrolyte membranes are also provided, together with methods of manufacturing the electrolyte membranes.

### FIELD OF THE INVENTION

The present invention relates to electrolyte membranes, and their use in electrochemical devices, such as water electrolysers, and includes catalyst-coated membranes (CCMs) incorporating such membranes, and methods of their manufacture.

### BACKGROUND

The electrolysis of water to produce high purity hydrogen and oxygen can be carried out in both alkaline and acidic electrolyte systems. Those electrolysers that employ a solid proton-conducting polymer electrolyte membrane, or proton exchange membrane (PEM), are known as proton exchange membrane water electrolysers (PEMWEs). Those electrolysers that utilise a solid anion-conducting polymer electrolyte membrane, or anion exchange membrane (AEM), are known as anion exchange membrane water electrolysers (AEMWEs).

A catalyst-coated membrane (CCM) may be employed within the stack of a water electrolyser. CCMs comprises an electrolyte membrane, such as a PEM or AEM, with at least one of an anode catalyst layer and a cathode catalyst layer coated on a face of the membrane. Typically for PEMWEs, cathode catalyst materials comprise platinum. Anode catalysts for PEMWEs typically comprise iridium or iridium oxide (IrOx) materials, or oxides containing both iridium and ruthenium.

To form a water electrolyser, additional layers are added either side of a CCM to make an assembly, sometimes referred to as a membrane electrode assembly (MEA). These additional layers may include a porous transport layer (PTL) on the anode side and a gas diffusion layer (GDL) on the cathode side of the CCM. These layers may or may not be directly attached to the CCM. Other components may include bipolar plates and current collector plates. Stacks of such assemblies make up an electrolyser system including power and control systems.

Electrolyte membranes, such as PEMs and AEMs, are also used in fuel cells. In proton exchange membrane fuel cells (PEMFC) the membrane is proton-conducting, and protons, produced at the anode, are transported across the membrane to the cathode, where they combine with oxygen to form water.

It is desirable to reduce the thickness of membranes used in electrochemical devices, such as water electrolysers, to minimise electronic and ionic resistance. However it is also important to minimise any hydrogen crossover through the membrane, to avoid hydrogen mixing with oxygen and associated safety concerns.

For water electrolysers, it is beneficial to maintain low levels of hydrogen crossover even at high pressure differentials across the membrane. The use of high pressures during electrolyser operation is advantageous as it reduces the extent of compression required of the generated hydrogen and reduces operating costs. This has led to the use of membranes with a thickness of over 125 μm, and typically close to 200 μm, or thicker. Examples of currently used membranes include Nafion™ N115 (thickness 125 μm) or Nafion™ N117 (thickness 175 μm).

It is also important that membranes are stable during long term electrochemical operation to minimise maintenance and the replacement of expensive components.

It is known to coat membrane components with a catalyst layer suitable for catalysing a recombination reaction of molecular oxygen and hydrogen. For example, it is described in WO2018/115821 (Johnson Matthey Fuel Cells Ltd) that a Pt/C supported catalyst may be coated onto one surface of a membrane and this membrane laminated with other membrane layers to form a CCM component for PEM water electrolysers.

It is also known to produce proton exchange membranes comprising a supported recombination catalyst. For example, it is described in WO2020/148545 (Johnson Matthey Fuel Cells Ltd) that a catalyst comprising platinum nanoparticles on a graphene support may be introduced into a membrane.

There remains a need to further enhance and develop membranes for electrochemical applications, for example for water electrolysis applications, which enable efficient operation at high pressure differentials across the membrane.

### SUMMARY OF THE INVENTION

The present inventors have surprisingly found that electrolyte membranes with a thickness of less than or equal to 100 μm may be produced with an excellent balance of low hydrogen crossover and high ionic conductivity. Such membranes may be produced by dispersing unsupported recombination catalyst particles in a membrane layer with a controlled thickness, and forming the membrane as a single coherent membrane without lamination interfaces. Such membranes enable the incorporation of a recombination catalyst whilst maintaining high ion-conductivity.

Therefore, in a first aspect of the invention there is provided an electrolyte membrane comprising a recombination catalyst layer, such as a proton exchange membrane, the membrane having a thickness of less than or equal to 100 μm, and wherein the recombination catalyst layer satisfies the following requirements:
(i) the layer comprises particles of an unsupported recombination catalyst dispersed in an ion conducting polymer;
(ii) the layer has a thickness in the range of and including 5 to 30 μm
   and the electrolyte membrane is a single coherent polymer film comprising a plurality of ion conducting polymer layers.

Such membranes are particularly suitable for use in a water electrolyser. Providing the membrane as a single non-laminated component, rather than, for example, two or more membrane components laminated together, additionally offers stability benefits and manufacturing process efficiencies on a large scale.

The membranes of the first aspect have particular utility as components of a catalyst coated membrane (CCM). It has been found that such CCMs offer an excellent balance between membrane resistance and low hydrogen cross-over during operation. Therefore, in a second aspect of the invention there is provided a CCM for an electrochemical device, comprising a membrane according to the first aspect.

Suitably, the CCM is for a water electrolyser, such as a PEM water electrolyser. In such cases the CCM comprises a cathode catalyst layer for catalysing a hydrogen evolution reaction and/or an anode catalyst layer for catalysing an oxygen evolution reaction. Typically, the cathode catalyst layer comprises platinum and/or the anode catalyst layer comprises iridium.

The CCM may also be for a fuel cell, such as a PEM fuel cell. In such cases the CCM comprises a cathode catalyst layer for catalysing an oxygen reduction reaction and/or an anode catalyst layer for catalysing a hydrogen oxidation reaction.

In a third aspect of the invention there is provided a water electrolyser or a fuel cell comprising a membrane according to the first aspect, or a catalyst coated membrane according to the second aspect.

The present inventors have also advantageously found that electrolyte membranes comprising a recombination catalyst layer as described herein may be prepared through the preparation of an ink, preferably with control of recombination catalyst particle size distribution, and then using such an ink to prepare the recombination catalyst layer. Therefore in a fourth aspect of the invention there is provided a method of manufacturing an electrolytic membrane, according to the first aspect, the method comprising the steps of:
(i) forming an ink comprising particles of an unsupported recombination catalyst and an ion conducting polymer;
(ii) fabricating a recombination catalyst layer from the ink.

### BRIEF DESCRIPTION OF THE FIGURES

FIG. 1 shows a schematic of an example arrangement of an electrolyte membrane of the invention.

FIG. 2 shows a schematic of an example arrangement of a catalyst coated membrane of the invention.

FIG. 3 shows a scanning electron microscopy (SEM) image of a membrane formed in accordance with Example 1.

FIG. 4 shows the results of hydrogen crossover testing of membranes produced in the Examples.

FIG. 5 shows the results of electrical testing of 80 μm membranes produced in the Examples.

### DETAILED DESCRIPTION

Preferred and/or optional features of the invention will now be set out. Any aspect of the invention may be combined with any other aspect of the invention unless the context demands otherwise. Any of the preferred and/or optional features of any aspect may be combined, either singly or in combination, with any aspect of the invention unless the context demands otherwise.

The present invention provides electrolyte membranes. It may be preferred that the membrane is a proton exchange membrane (PEM), such as a PEM for a water electrolyser. It will however be understood by the skilled person that the recombination catalyst layers as described herein would have utility in other types of electrolyte membrane, such as proton exchange membranes for fuel cells, and anion exchange membranes for water electrolysers, fuel cells or other applications.

The membranes have a thickness of less than or equal to 100 μm. It may be preferred that the membrane has a thickness of less than or equal to 95 μm, 90 μm, or 85 μm. It may be preferred that the membrane has a thickness of at least 10 μm, such as at least 15 μm, at least 20 μm, at least 25 μm, at least 30 μm or at least 40 μm. It may be further preferred that the membrane has a thickness in the range of and including 10 to 100 μm, such as 15 to 100 μm, 20 to 100 μm, 30 to 100 μm, 30 to 90 μm, or 40 to 90 μm.

The membrane thickness (and the thickness of layers of the membranes) may be measured by scanning electron microscopy (SEM). SEM analysis is carried out on cross sections of the membrane and the membrane and/or layer thickness measured at multiple (for example 10) points. The thickness values are then determined by calculating the arithmetic mean of the measured values.

The membranes comprise a recombination catalyst layer. By recombination catalyst it is meant a catalyst which catalyses the reaction between hydrogen and oxygen to form water. Accordingly, the recombination catalyst used in the recombination catalyst layer of the present invention may be any catalyst capable of catalysing the reaction between hydrogen and oxygen to form water, thus reducing or preventing the crossover of either hydrogen or oxygen, or both, through the membrane. It will be understood by the skilled person that the membrane may comprise more than one recombination catalyst layer, such as two or more recombination catalyst layers. It may be preferred that the membrane has a single recombination catalyst layer.

Suitably, the recombination catalyst is selected from one or more of platinum, palladium, and alloys or mixed oxides thereof. Preferably, the recombination catalyst is platinum, or a platinum alloy, such as platinum alloyed with one or more other platinum group metals (i.e. the group of elements comprising platinum, palladium, iridium, rhodium, ruthenium, and osmium) or alloyed with cobalt. It may be particularly preferred that the particles of an unsupported recombination catalyst consist of platinum.

The recombination catalyst is unsupported. The term unsupported will be readily understood by the skilled person. For example, it will be understood that the catalyst particles are not bound or fixed to a catalyst support, such as a carbon support, by physical or chemical bonds, e.g. by way of ionic or covalent bonds, or non-specific interactions such as an der Waals forces. It has been found that the use of an unsupported recombination catalyst facilitates ink processing prior to membrane formation, and offers increased membrane stability during electrochemical operation, avoiding routes of degradation via corrosion of the catalyst support.

The recombination catalyst layer is a membrane layer which comprises particles of an unsupported recombination catalyst dispersed in an ion conducting polymer.

In cases in which the membrane is for a PEM electrochemical device, the ion conducting polymer is suitably a proton conducting polymer, and in particular a partially- or fully-fluorinated sulphonic acid polymer. Examples of suitable proton-conducting polymers include perfluorosulphonic (PFSA) acid polymers, such as perfluorosulphonic acid polymers available from 3M Corporation or Aquivion® ion-conducting polymers available from Solvay. It may be preferred that the ion conducting polymer is a PFSA polymer and has an equivalent weight (EW) greater than 750 EW, greater than 760 EW, greater than 770 EW, or greater than 790 EW. For example, it may be preferred that the ion conducting polymer is a PFSA polymer with an equivalent weight in the range of and including 750 to 1200 EW, such as in the range of an including 770 to 1000 EW, or 800 to 900 EW. It may be preferred that the equivalent weight of the ion conducting polymer in the recombination catalyst layer is greater than the equivalent weight ion conducting polymer in any other layers of the membrane.

By dispersed in the ion conducting polymer it is meant herein that the particles of unsupported recombination catalyst are distributed throughout the recombination catalyst layer, i.e. they are not located in a discrete layer or region of the recombination catalyst layer.

It is preferred that the particles of unsupported recombination catalyst have a particle size distribution such that the d90 is less than or equal to 3.0 μm. The use of particles with a d90 less than or equal to 3.0 μm offers improved mechanical stability in thin membrane layers (such as layers with a thickness less than 30 μm) and offers benefits associated with ink processability and the use of ink in coating equipment. The term d90 as used with regards to the particle size distribution in the membrane refers to the number distribution of particle size (the value of particle diameter at 90% in the cumulative number distribution, i.e. 90% of the total particles in the sample have a diameter smaller than this value). The d90 of particles in the membrane may be determined by scanning electron microscopy (SEM), for example analysing a cross section of the membrane by SEM and, from the resulting image, measuring the diameter of a population of (e.g. 100) particles by image analysis and then calculating the d90.

It may be preferred that the d90 is less than or equal to 2.8 μm, 2.6 μm, 2.5 μm, 2.4 μm, 2.3 μm, 2.2 μm, 2.1 μm or 2.0 μm. It may be preferred that the particles of unsupported recombination catalyst have a particle size distribution such that the d90 is greater than or equal to 1.0 μm, 1.5 μm, 1.7 μm, or 1.9 μm. It may be further preferred that the particles of unsupported recombination catalyst have a particle size distribution such that the d90 is in the range of and including 1.0 to 3.0 μm, or 1.5 to 3.0 μm, such as 1.5 to 2.8 μm, or 1.5 to 2.6 μm.

Typically, the particles of unsupported recombination catalyst have an average particle size greater than or equal to 0.1 μm. The average particle size may be determined by scanning electron microscopy (SEM), for example analysing a cross section of the membrane by SEM, and from the resulting image measuring the diameter of a population of (e.g. 100) observable particles by image analysis and then calculating the average (mean) particle size. The use of particles greater than 0.1 μm offers advantages with regards to efficient ink preparation and their use has been shown to provide significant reduction in hydrogen crossover.

It may be preferred that the average particle size is greater than or equal to 0.2 μm, 0.3 μm, 0.4 μm, 0.5 μm, 0.6 μm, 0.7 μm, 0.8 μm, or 0.9 μm. It may be preferred that the particles of unsupported recombination catalyst have an average particle size less than or equal to 2.0 μm, 1.8 μm, 1.6 μm, 1.5 μm, 1.4 μm, 1.3 μm or 1.2 μm. It may be preferred that the particles of unsupported recombination catalyst have an average particle size in the range of and including 0.2 to 2.0 μm, 0.5 to 2.0 μm, such as 0.7 to 1.8 μm, or 0.8 to 1.5 μm.

Preferably, the electrolyte membrane has a recombination catalyst loading (e.g. platinum loading) in the range of and including 5 to 50 μg/cm⁻², 5 to 40 μg/cm 2, 5 to 30 μg/cm⁻², 5 to 20 μg/cm⁻², such as in the range of and including 8 and 15 μg/cm⁻². It has been found that this range of catalyst loading provides a suitable balance between reducing the level of hydrogen crossover during use and the cost associated with the inclusion of catalyst in the membrane. The catalyst loading may be determined by inductively coupled plasma mass spectrometry (ICP-MS).

The recombination catalyst layer has a thickness in the range of and including 5 to 30 μm. The dispersion of particles of an unsupported recombination catalyst in a membrane layer of at least 5 μm offers improved membrane stability benefits in comparison with the use of thinner catalyst layer, e.g. applied to a membrane surface. The use of a recombination catalyst layer with a thickness greater than 30 μm is not required to substantially reduce hydrogen crossover and can provide manufacturing difficulties, in particular when forming non-laminated membrane structures. The thickness of the recombination catalyst layer may be determined by SEM analysis of a cross-section of the membrane. It may be preferred that the recombination catalyst layer has a thickness in the range of and including 5 to 20 μm, such as between 7 and 15 μm. Such thicknesses offer a suitable balance between the reduction of hydrogen crossover by the formed membrane and manufacturing efficiency.

The membranes are formed by methods that do not require lamination steps to form the membrane, for example by depositing multiple layers of ion conductive polymer on top of each other via a liquid phase deposition process such as printing, spraying, or coating.

The membrane is a single coherent polymer film comprising a plurality of ion conducting polymer layers. The term ‘coherent’ as used herein means that the membrane is free from internal lamination interfaces.

Lamination of ion conductive membranes comprises pressing and/or bonding at least two solid ion conductive membranes together, such membranes optionally being coated with a catalyst layer. A lamination interface is formed between the two membranes where solid surfaces of the individual membranes are pressed and/or bonded together. Lamination interfaces comprise physical defects. Furthermore, the structural and/or chemical nature of a lamination interface also differs from that of the bulk polymer material. This is because when a solid membrane is formed, the outer surfaces of the solid membrane have surface features which are distinct from those in the bulk material. For example, a hydrophobic skin forms on a surface of a membrane at an air interface. Raman spectroscopy can detect this difference. As such, when two solid membranes are pressed together, the lamination interface formed by the two solid surfaces is distinctive in chemical and/or structural form compared to the bulk of the ion conductive polymer material. Microscopy and spectroscopy techniques can thus distinguish between lamination interfaces between layers of ion conductive polymer and interfaces which have been formed via a liquid phase deposition process such as printing, spraying, or coating of layers to build up a multi-layer structure. That is, a non-laminated interface is structurally and/or chemically distinct from a laminated interface and is not just a feature of the manufacturing method. Furthermore, a non-laminated interface can be identified as being non-laminated in a membrane without prior knowledge of the manufacturing method. Examples of analysis techniques for detecting a laminated interface include cross-section SEM. Variations of crystallinity at interfaces can be detected using cross-section TEM. Other techniques for detecting laminated interfaces include 13C/1H/19F solid state NMR, neutron diffraction, and/or a combination of two or more of the aforementioned techniques.

Due to physical defects and/or chemical variations at lamination interfaces between ion conductive polymer membranes, such interfaces can increase the resistance of a multi-layer ion conductive membrane. As such, it has been found to be advantageous to fabricate a multi-layer ion conductive membrane by depositing layers of ion conducting polymer dispersed in a liquid solvent to build up a multi-layer membrane structure rather than via lamination of individual solid layers/membranes of ion conductive polymer.

Preferably, the membrane comprises a reinforcement polymer, such as expanded polytetrafluoroethylene (ePTFE) or polybenzimidazole (PBI). It may be preferred that the recombination catalyst layer does not comprise a reinforcement polymer.

The reinforcement material may comprise a porous reinforcement polymer sheet which is impregnated with ion conducting polymer, the reinforcement material optionally being expanded polytetrafluoroethylene (ePTFE). As typical reinforcement polymer materials are not conductive to ions, or not sufficiently conductive to ions, the reinforcement layer is thus formed using a porous reinforcement polymer which is impregnated with ion conducting polymer through the pores of the material to provide ion conductive paths from one side of the layer to the other side of the layer.

Preferably, the membrane comprises a radical reducing additive (e.g. peroxide radical reducing additive, such as ceria). It will be noted that peroxide can decompose to form a range of radicals (O, OH, OOH) and the radical reducing additive may reduce the amount of one, more, or all of these radicals. The radical reducing additive may be dispersed within the recombination catalyst layer.

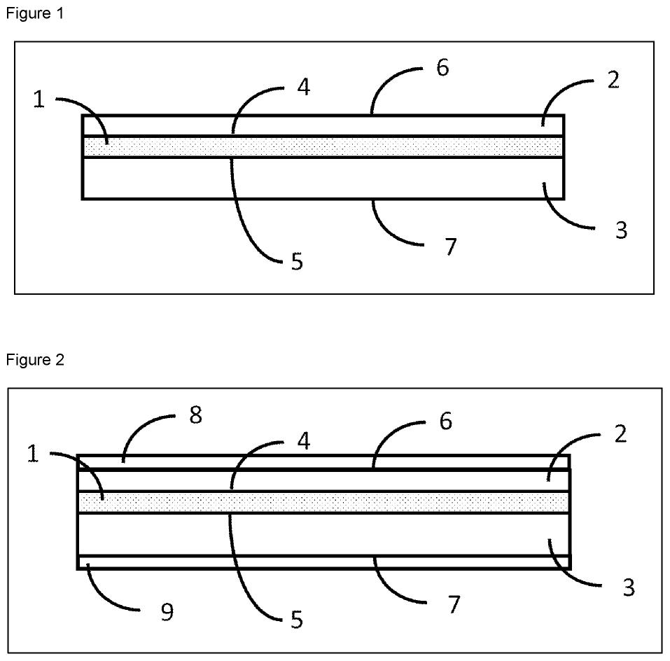

Typically, the membrane is configured such that, referring to FIG. 1, the recombination catalyst layer (1) is disposed between a first ion conducting polymer layer (2) and a second ion conducting polymer layer (3). In such configurations, the second face (4) of the first ion conducting polymer layer (2) and the second face (5) of the second ion conducting polymer layer (3) each face inwards, towards the recombination catalyst layer (1). The first face (6) of the first ion conducting polymer layer (2) and the first face (7) of the second ion conducting polymer layer (3) are the outer surfaces of the membrane, i.e. facing towards the anode and the cathode when incorporated into, for example, a water electrolyser.

Suitably, the membrane consists of a recombination catalyst layer disposed between a first ion conducting polymer layer and a second ion conducting polymer layer. It will be understood by the skilled person that the first ion conducting polymer layer and a second ion conducting polymer layer may be formed from one or more sub-layers, which may be of the same or different composition.

In cases in which the membrane is for a PEM electrochemical device, the ion conducting polymer present in the first and second ion conducting polymer layers is suitably a proton conducting polymer and in particular a partially- or fully-fluorinated sulphonic acid polymer. Examples of suitable proton-conducting polymers include the perfluorosulphonic acid ionomers, such as perfluorosulphonic acid ionomers available from 3M Corporation or Aquivion® ion-conducting polymers available from Solvay. It may be preferred that the ion conducting polymer in the first and/or the second ion conducting layer is the same as the ion conducting polymer in the recombination catalyst layer. It may alternatively be preferred that the ion conducting polymer in the first and/or the second ion conducting layers is different to the ion conducting polymer in the recombination catalyst layer.

Typically, a reinforcement polymer and/or a radical reducing agent (e.g. a peroxide radical reducing additive, such as ceria) is present in the first and/or the second ion conducting polymer layer.

It may be preferred that the thickness of the first ion conducting polymer layer is less than the thickness of the second ion conducting polymer layer. This asymmetry enables the recombination catalyst layer to be placed closer to the anode than the cathode in a water electrolyser configuration, which is considered beneficial for the reduction in hydrogen crossover.

It may be preferred that the first ion conducting polymer layer has a thickness in the range of and including 5 to 30 μm, such as in the range of and including 5 to 20 μm, or from 5 to 15 μm, or 7 to 15 μm. Such a thickness for the first ion conducting polymer layer is considered by the present inventors to provide a suitable distance between the anode layer and the recombination catalyst in a formed CCM for a water electrolyser to provide a significant reduction in hydrogen crossover.

It may be preferred that the second ion conducting polymer layer has a thickness in the range of and including 10 to 90 μm, such as in the range of and including 20 to 70 μm, 40 to 70 μm, or 25 to 45 μm.

The thickness of the ion conducting polymer layers may be adjusted, for example, by varying the number of deposition passes of ion conducting polymer during manufacture of the membrane, or by variation in the pump speed during deposition of ion-conducting polymer.

It may be preferred that the membrane comprises or consists of (i) a first ion conducting layer with a thickness in the range of and including 5 to 15 μm; (ii) a second ion conducting layer with a thickness in the range of and including 25 to 45 μm; and (iii) a recombination catalyst layer with a thickness in the range of and including 5 to 15 μm, and which is disposed between the first ion conducting layer and the second ion conducting layer. In such configurations it is preferred that the second ion conducting layer comprises a reinforcement polymer, such as expanded polytetrafluoroethylene (ePTFE) or polybenzimidazole (PBI). Such a membrane structure provides has been found to provide a particularly suitable balance between membrane resistance and level of hydrogen crossover.

It may be preferred that the membrane comprises or consists of (i) a first ion conducting layer with a thickness in the range of and including 5 to 15 μm; (ii) a second ion conducting layer with a thickness in the range of and including 40 to 70 μm; and (iii) a recombination catalyst layer with a thickness in the range of and including 5 to 15 μm and which is disposed between the first ion conducting layer and the second ion conducting layer. In such configurations it is preferred that the second ion conducting layer comprises a reinforcement polymer, such as expanded polytetrafluoroethylene (ePTFE) or polybenzimidazole (PBI). It may be further preferred that the second ion conducting layer contains two regions of reinforcement polymer, such as two sub-layers comprising a reinforcement polymer, such as expanded polytetrafluoroethylene (ePTFE) or polybenzimidazole (PBI). Such a membrane structure enables operation at particularly high gas pressure differentials across the membrane whilst maintaining hydrogen crossover and low membrane resistance.

The membranes as described herein may suitably be used as part of a catalyst coated membrane (CCMs). Such CCMs have an anode catalyst layer and/or a cathode catalyst layer applied to a face of the membrane.

In the case of a CCM for a water electrolyser, a cathode catalyst layer may be applied to a surface of the membrane comprising a catalyst for catalysing the hydrogen evolution reaction. It may be preferred that the cathode catalyst layer comprises platinum, for example a platinum-on-carbon catalyst. The catalyst material can be formulated into an ink, printed ex-situ onto a PTFE sheet, and transferred onto the membrane by hot pressing. Alternatively, the ink can be directly coated onto the membrane.

It may be preferred that the cathode catalyst layer comprises platinum and has a platinum loading, provided by the platinum material (such as a platinum-on-carbon material), of less than 1 mg^{Pt} cm⁻². Surprisingly, it has been found that when using a platinum-on-carbon catalyst material, reducing the platinum loading actually leads to an improvement in performance in terms of current density. That is, reducing the platinum loading using a platinum-on-carbon catalyst material surprisingly resulted in an increase in the current density for a given potential. That said, there is also a lower limit to the amount of platinum which must be provided. As such, the platinum loading of the cathode layer is suitably more than 0.01 mg_{Pt} cm⁻², 0.04 mg^{Pt} cm⁻², or 0.06 mg_{Pr} cm⁻².

The cathode catalyst layer may comprise a platinum-on-carbon catalyst material which is between 20 and 60 wt % platinum, optionally between 40 and 60 wt % platinum. The platinum may be advantageously provided as nanoparticles on the carbon support material. The nanoparticles of platinum may have a crystallite size of: at least 1 nm, 2 nm, or 3 nm; no more than 15 nm, 10 nm, or 6 nm; or within a range defined by any combination of the aforementioned lower and upper limits. Crystallite size can be measured through XRD and fitted using Rietveld analysis. X-ray diffraction data is collected using Cu Kα radiation (λ=1.5406 and 1.54439 Å) on a Bruker AXS D8. Crystallite sizes are calculated from the Rietveld refinements using the LVol-IB method.

The cathode catalyst layer may comprise a platinum-on-carbon catalyst material in which the carbon support material is a partially graphitized carbon material (e.g., a heat-treated carbon black). Graphite material is more corrosion resistant. However, graphite support materials have a low surface area. As such, there is a compromise between the requirements of high surface area and high corrosion resistance. A partially graphitized material has been found to be a good compromise between surface area requirements and corrosion resistance requirements for the carbon support in this water electrolyser application.

Typically the cathode catalyst layer comprises both catalyst and an ion conducting polymer. The ion conducting polymer in the cathode catalyst layer may be an ionomer, such as a perfluorosulphonic (PFSA) acid polymer, with an equivalent weight of: no more than 880 EW, 850 EW, or 830 EW; no less than 750 EW, 770 EW, or 790 EW; or within a range defined by any combination of the aforementioned upper and lower limits. The side chains of the cathode layer ion conducting polymer typically each comprise a sulphonate group. The side chains of the cathode layer ion conducting polymer may have the structure: —CF₂—CF₂—CF₂—CF₂—SO3_{H}. An example of such an ionomer is 800 EW 3M C4 side chain. The ion conducting polymer of the cathode layer may be the same or similar to that used in the membrane.

The cathode catalyst layer may have an ion conducting polymer/carbon weight ratio in the range of and including 0.6 and 1.0 (noting that this is the weight ratio between the ion conducting polymer and carbon, the platinum is not taken into account in this calculation). Furthermore, the cathode catalyst layer may have a thickness in the range of any including 1 to 15, 4 to 15, or 8 to 15 μm.

An example of such a cathode layer comprises the following features:
Nominal Pt Loading—0.4 mg Pt cm⁻²
Ion conducting polymer—Ionomer 800 EW 3M C4 side chain
Ion conducting polymer/Carbon weight ratio—0.8
Thickness—approximately 10 to 11 μm
Catalyst is 50 wt % Pt-on-carbon
Carbon is a partially graphitized carbon support material

In the case of a CCM for a water electrolyser, an anode catalyst layer may be applied to a surface of the membrane comprising a catalyst for catalysing the oxygen evolution reaction. In the case that the CCM is for a PEMWE, it may be preferred that the anode catalyst layer comprises iridium, such as iridium oxide or mixed oxides of iridium and another metal or metals.

The anode material can be formulated into an ink, suitably in an ion conducting polymer, printed ex-situ onto a PTFE sheet, and transferred onto the membrane by hot pressing. Alternatively, the ink can be directly coated onto the membrane.

The anode catalyst layer typically comprises both catalyst and an ion conducting polymer. Advantageously, the ion conducting polymer of the anode catalyst layer differs from the ion conducting polymer in the membrane in that it has one or more of: a higher equivalent weight than the membrane ion conducting polymer; longer side chains than the membrane ion conducting polymer; and/or different chemical groups in the side chains compared to the membrane ion conducting polymer. In contrast, the ion conducting polymer used in the cathode catalyst layer is typically the same or similar to that used in the ionomer membrane.

The ion conducting polymer in the anode catalyst layer preferably has an equivalent weight of: no less than 900 EW, 950 EW, 1000 EW, or 1050 EW; no more than 1300 EW, 1200 EW, or 1150 EW; or within a range defined by any combination of the aforementioned lower and upper limits. The side chains of the ion conducting polymer typically each comprise a sulphonate group. Optionally, the side chains of the ion conducting polymer include an ether group in addition to the ether linkage to the backbone. Furthermore, optionally, the side chains of the ion conducting polymer include a CF₃ group. The side chains of the ion conducting polymer may have the structure: —CF₂—CF(CF₃)—O—CF₂—CF₂—SO₃H. An example of such an ionomer is Nafion D-2021CS. Nafion D-2021CS is a high equivalent weight ionomer that has long side chains with sulfonate end groups. In the presence of water these sulfonate groups hydrate, solvate, and dissociate into protons and this allows the exchange of protons from anode to cathode. In contrast, the ion conducting polymer in the membrane can be for example 3M 800, 3M 825, or Asahi 800 ionomer. These ion conducting polymers have a lower equivalent weight and shorter side chains.

The anode catalyst layer may comprise between 5 and 20 wt % ion conducting polymer, for example between 8 and 15 wt %. Suitably, the amount of catalyst material in the anode catalyst layer can be 80 to 95 wt %, optionally between 85 and 92 wt %. The iridium loading of the anode catalyst layer is preferably less than 3 mg Ir/cm², optionally in a range 0.05 and 3 mg Ir/cm². The iridium containing catalyst material can be an iridium oxide catalyst material and the anode catalyst layer may have a thickness between 6 and 15 μm.

Typically, the CCM comprises a membrane which comprises a first ion conducting polymer layer and a second ion conducting polymer layer with the recombination catalyst layer disposed between the first and second ion conducting polymer layers as described hereinbefore. It is preferred that CCM is configured such that the recombination catalyst layer is closer to the anode catalyst layer than the cathode catalyst layer. It may be further preferred that the thickness of the second ion conducting polymer layer is greater than the thickness of the first ion conducting polymer layer Such a configuration is proposed to have benefits with regards to reduction of hydrogen crossover.

Suitably, the CCM is configured such that, referring to FIG. 2, the second face (4) of the first ion conducting polymer layer (2) and the second face (5) of the second ion conducting polymer layer (3) each face inwards, towards the recombination catalyst layer (1). The anode catalyst layer (8), if present, is provided on the first face (6) of the first ion conducting polymer layer (2). The cathode catalyst layer (9), if present, is provided on the first face (6) of the second ion conducting polymer layer (3).

It may be preferred that the catalyst coated membrane comprises a membrane which comprises or consists of (i) a first ion conducting layer with a thickness in the range of and including 5 to 15 μm; (ii) a second ion conducting layer with a thickness in the range of and including 25 to 45 μm; and (iii) a recombination catalyst layer with a thickness in the range of and including 5 to 15 μm and which is disposed between the first ion conducting layer and the second ion conducting layer, and wherein the second face of the first ion conducting polymer layer and the second face of the second ion conducting polymer layer each face inwards, towards the recombination catalyst layer, and wherein an anode catalyst layer as described hereinbefore is provided on the first face of the first ion conducting layer and/or a cathode catalyst layer as described hereinbefore is provided on the first face of the second ion conducting layer. In such configurations it is preferred that the second ion conducting layer comprises a reinforcement polymer, such as expanded polytetrafluoroethylene (ePTFE) or polybenzimidazole (PBI).

It may be preferred that the catalyst coated membrane comprises a membrane which comprises or consists of (i) a first ion conducting layer with a thickness in the range of and including 5 to 15 μm; (ii) a second ion conducting layer with a thickness in the range of and including 40 to 70 μm; and (iii) a recombination catalyst layer with a thickness in the range of and including 5 to 15 μm and which is disposed between the first ion conducting layer and the second ion conducting layer, and wherein the second face of the first ion conducting polymer layer and the second face of the second ion conducting polymer layer each face inwards, towards the recombination catalyst layer, and wherein an anode catalyst layer as described hereinbefore is provided on the first face of the first ion conducting layer and/or a cathode catalyst layer as described hereinbefore is provided on the first face of the second ion conducting layer. In such configurations it is preferred that the second ion conducting layer comprises a reinforcement polymer, such as expanded polytetrafluoroethylene (ePTFE) or polybenzimidazole (PBI). It may be further preferred that the second ion conducting layer contains two regions of reinforcement polymer, such as two sub-layers comprising a reinforcement polymer, such as expanded polytetrafluoroethylene (ePTFE) or polybenzimidazole (PBI).

Also provided is a method of manufacturing an electrolyte membrane as described hereinbefore, the method comprising the steps of:
(i) forming an ink comprising particles of an unsupported recombination catalyst and an ion conducting polymer;
(ii) fabricating a recombination catalyst layer from the ink.

In cases, in which the particles of an unsupported recombination catalyst are platinum particles, it is preferred that the particles of platinum are provided as platinum black. It has been found that platinum black may be processed efficiently to provide an ink suitable for use in the methods as described herein and shows reduced agglomeration during ink formation than other platinum sources, such as platinum on carbon.

Preferably, the particles of unsupported recombination catalyst in the ink have a d90 less than 3.0 μm. The particle size distribution may be determined by using a laser diffraction method. For example, the d90 may be determined by diluting the ink in 80:20 (v/v) ethanol:water and analysing the particle size distribution by laser diffraction, such as by using a Malvern Mastersizer 3000. The term d90 with reference to the particles in the ink refers to the volume-based particle size (the value of particle diameter at 90% in the cumulative volume distribution, i.e. 90 vol % of the particles in the sample have a diameter smaller than this value)

The desired particle size distribution may be suitably achieved by processing the ink using a high shear techniques, for example microfluidisation. It may be preferred that forming the ink in step (i) comprises passing a dispersion of a platinum source, such as platinum black, and an ion conducting polymer through a microfluidizer.

The ink typically comprises the ion conducting polymer dispersed in a solvent. The solvent may be a mixture of an organic solvent and water. For example, the solvent may be a mixture of an alcohol (e.g. ethanol or propanol) and water. The volume ratio of organic solvent, such as ethanol, to water may be: at least 60:40, 70:30, or 75:25; no more than 95:5; 90:10, or 85:15; or within a range defined by any combination of the aforementioned lower and upper limits. The solvent is formulated for achieving the desired dispersion, coating, and drying characteristics.

The ion conducting polymer may be provided in the ink at a weight percentage with respect to the total weight of recombination catalyst and ion conducting polymer: at least 7 wt %, 10 wt %, 14 wt %, or 16 wt %; no more than 22 wt %, 20 wt %, or 18 wt %; or within a range defined by any combination of the aforementioned lower and upper limits. The ion conducting polymer content is selected for achieving the desired dispersion, coating, and drying characteristics.

The ink may also comprise a radical reducing additive (e.g., a peroxide radical reducing additive such as ceria). For example, the radical reducing additive may be provided in the dispersion at a weight percentage, relative to the weight of ion conducting polymer, of: at least 0.15 wt %, 0.20 wt %, or 0.23 wt %; no more than 0.35 wt %, 0.30 wt %, or 0.28 wt %; or within a range defined by any combination of the aforementioned lower and upper limits.

The method comprises the step of fabricating a recombination catalyst layer from the ink. The recombination catalyst layer is typically formed by casting or printing the ink onto a substrate to form the layer. The layer thus formed can be dried, or at least partially dried, typically prior to deposition of a further layer of ionomer thereover.

Typically, the substate is a layer of ion conducting polymer layer, such as the first or the second ion conducting polymer layer. It may be preferred that step (ii) comprises fabricating a recombination catalyst layer from the ink by depositing the ink onto a first ion conducting polymer layer.

Further ion conducting polymer layers may be deposited to form the membrane. It may be preferred that the method comprises step (iii) adding a second ion conducting polymer layer such that the recombination catalyst layer is disposed between the first and second ion conducting polymer layers.

The membrane may be formed by sequential printing of layers. As an example, the membranes may be formed as follows. In the first pass an ion conducting polymer layer is applied onto a backing layer. The first ion conducting polymer layer is then dried. In the second pass an ink containing the recombination catalyst is applied onto the first ion conducting polymer layer. The recombination catalyst layer is then dried. This sequence of application and drying is continued to produce further ion conducting polymer sub-layers during further passes to form a second ion conducting polymer layer. A reinforcement material may be included in one or more of the coating passes.

The membrane structure as described above can be coated with a cathode catalyst and an anode catalyst to form a catalyst coated membrane (CCM) for a water electrolyser. The specific type of catalysts for the cathode and anode can be varied. Furthermore, the method of deposition can be varied. An example of a suitable cathode catalyst for a water electrolyser is a platinum on carbon catalyst, optionally provided as a decal. In the case of CCMs for PEMWEs, iridium oxide-based catalysts may be used for the anode. The iridium oxide-based catalyst can be prepared into an ink comprising ion conducting polymer, 1-propanol and water, and bar coated onto a sheet of Teflon and dried to form a decal. The catalyst decals can be hot pressed with the membrane to form a CCM.

The present invention will now be described with reference to the following examples, which are provided to assist with understanding the present invention and are not intended to limit its scope.

### EXAMPLES

### Example 1—Formation of a Recombination Catalyst-Containing Ink

A mixture of an ion conducting polymer (PFSA ionomer, 825 EW, 3M Advanced Materials) and ethanol:water (80:20) was prepared. Platinum black catalyst (Johnson Matthey plc) was added to the mixture with the target amount of platinum black of 8.8 wt % based on a total weight of platinum, ionomer, ethanol and water.

The mixture was passed through a micro fluidiser (Microfluidics M-110P) using a z-type chamber at 30,000 psi until the ink until there was significant reduction in observable viscosity.

Analysis of the particle size distribution of the platinum particles in the ink using a Mastersizer 3000 indicated that the d90 was around 0.9 μm and the d50 around 0.17 μm.

The concentrated ink was then diluted again using a mixture of 3M ionomer PFSA 825 EW and ethanol:water (80:20) in order to achieve ˜10 micrograms of Pt per cm² in the formed membrane.

### Example 2—Formation of 50-μm Proton Exchange Membrane Incorporating a Recombination Catalyst Layer

A 50-μm membrane incorporating a recombination catalyst layer was prepared using slot-dye coating using a series of five printing/coating passes onto a Diacel substrate (PET with one side release layer) with a recombination catalyst-containing ink produced in accordance with Example 1 used in the second pass.

All other layers were formed from an ink comprising perfluorosulfonic acid (PFSA) ionomer (3M 800 EW PFSA ionomer), ceria (˜0.3 wt % relative to weight of ionomer) in ethanol:water (80:20). Reinforcement polymer was added to the ink used in pass 3 by the inclusion of expanded polytetrafluoroethylene (ePTFE) reinforcement. The tables below summarize the materials and method for construction of the membrane.

The five coating passes for fabricating the 50-μm membrane are as follows:

| | First ion | | Second ion | | |
|---|---|---|---|---|---|
| | conducting | Recombination | conducting | | |
| | polymer layer | catalyst layer | polymer layer | | |
| | Pass | Pass | Pass | Pass | Pass |
| | 1 | 2 | 3 | 4 | 5 |
| Thickness (μm) | 8 | 10 | 14 | 10 | 8 |
| Pt recombination | | Yes | | | |
| catalyst | | | | | |
| ePTFE | | | Yes | | |
| reinforcement | | | | | |

The membrane was dried at a temperature between 10° and 160° C. and then annealed at 160° C.

### Example 3—Formation of 80-μm Proton Exchange Membrane Incorporating a Recombination Catalyst Layer and a Single Region with ePTFE Reinforcement

A membrane was produced in accordance with Example 2 with the addition of three further coating passes to form an 80-μm proton exchange membrane.

### Example 4-Formation of 80-μm Proton Exchange Membrane Incorporating a Recombination Catalyst Layer and with Two Regions with ePTFE Reinforcement

A membrane was produced in accordance with Example 1 using the following series of 7 passes:

| | Second ion conducting | | | | | Recombination | First ion conducting |
|---|---|---|---|---|---|---|---|
| | polymer layer | | | | | catalyst layer | polymer layer |
| | Pass 1 | Pass 2 | Pass 3 | Pass 4 | Pass 5 | Pass 6 | Pass 7 |
| Thickness (μm) | 9 | 18 | 9 | 9 | 18 | 9 | 8 |
| Pt recombination | | | | | | Yes | |
| catalyst | | | | | | | |
| ePTFE | | Yes | | | Yes | | |
| reinforcement | | | | | | | |

### Membrane Analysis and Characterisation

### Inductively Coupled Plasma Mass Spectrometry (ICP-MS):

The platinum loading in the 50-μm membrane generated in Example 2 was measured by ICP-MS as 13 μg/cm² (mass of Pt per cm² of membrane).

The platinum loading in the 80-μm membrane generated in Example 3 was measured by ICP-MS as 13 μg/cm².

Scanning electron microscopy (SEM): A cross section of each membrane after manufacture was embedded in resin, ground, polished and carbon coated for SEM. The samples were analysed using a Zeiss Ultra 55 Field emission electron microscope. The boundary between the recombination catalyst layer and another layer is identified by where the dispersion of recombination catalyst terminates.

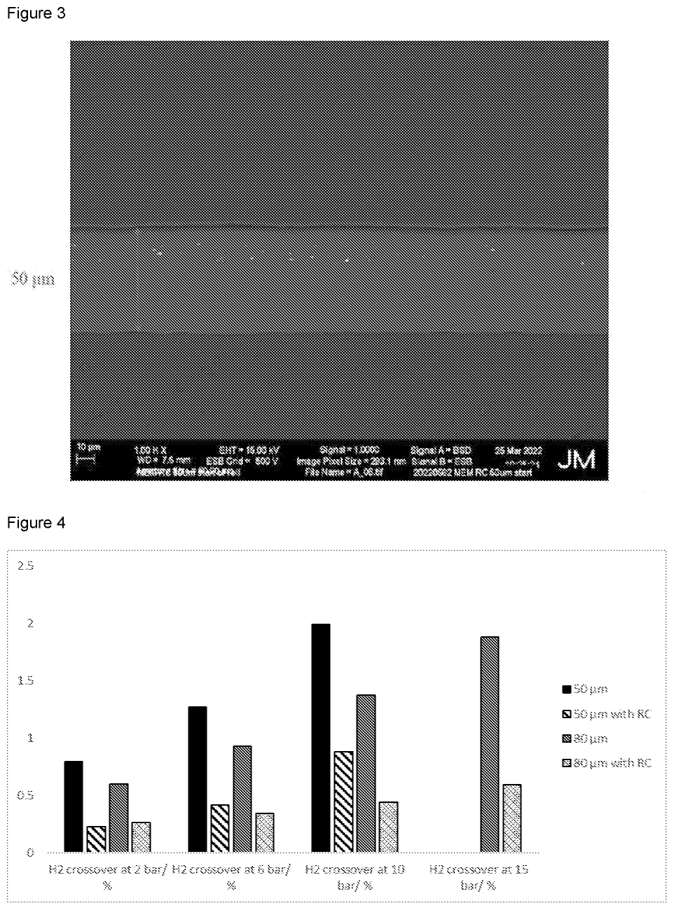

FIG. 3 shows an SEM image of a cross section of the 50-μm membrane. This shows a membrane thickness of 50-μm and the presence of platinum particles dispersed in a recombination catalyst layer of thickness around 12 μm.

Analysis of the platinum particle size distribution from SEM images of the 50 membrane indicates that the d90 is ˜2.5 μm and the d50 is about 1.2 μm.

### Testing of Catalyst Coated Membranes (CCMs)

CCMs were prepared using the 50 and 80 μm proton exchange membranes including recombination catalysts prepared according to the method of Example 2 and Example 3 and equivalent comparative examples produced in accordance with Example 2 and Example 3, but with a platinum-free ionomer ink used for pass 2 (i.e. no recombination catalyst). The CCMs were prepared with a Pt/C cathode catalyst layer (with a Pt loading of 0.37 mg cm⁻² of Pt) and an IrOx anode catalyst layer (with an Ir loading of 2 mg cm⁻²). In the case of the CCMs incorporating recombination catalyst, the anode layer was applied to the face of the membrane closest to the recombination catalyst layer.

### Hydrogen Crossover

The level of hydrogen crossover for each CCM was measured at different pressures using the following method:

A water electrolysis cell was prepared incorporating the catalyst-coated membrane to be tested. The cell temperature was held at to 80° C. and the anode and cathode pressure were set to 2 bar. Next, the current density was set to 2 A/cm². The cathode pressure was increased stepwise from 2 to 6, 10 and 15 bar with a minimal duration of 45 minutes for each step. The % of H₂ in the oxygen at the anode gas outlet was measured by a Compact GC 4.0 Gas Chromatograph (GC) from Global Analysis Solutions.

FIG. 4 shows the results of the testing of the CCMs. These results show a significant reduction in hydrogen crossover for membranes produced in accordance with Example 2 and Example 3, even at high pressure differentials across the membrane. The 80 μm proton exchange membranes formed in accordance with Example 3 provides the best performance at high pressure differentials.

### Electrical Performance

The electrical performance of the CCMs was tested by the following method:

The CCM was first conditioned via potentiostatic stabilisation at 2 V, 80° C. for 18-24 h. Then the polarisation measurement was performed. Anode and cathode pressures were kept equal at 2 bar. The measurement was carried out in a V shape starting at 3 A/cm² at 80° C. to 0.1 A/cm² and back to 3.0 A/cm². in step sizes of 0.1 A/cm². The upward going measurement (low to high current) was used for further analysis.

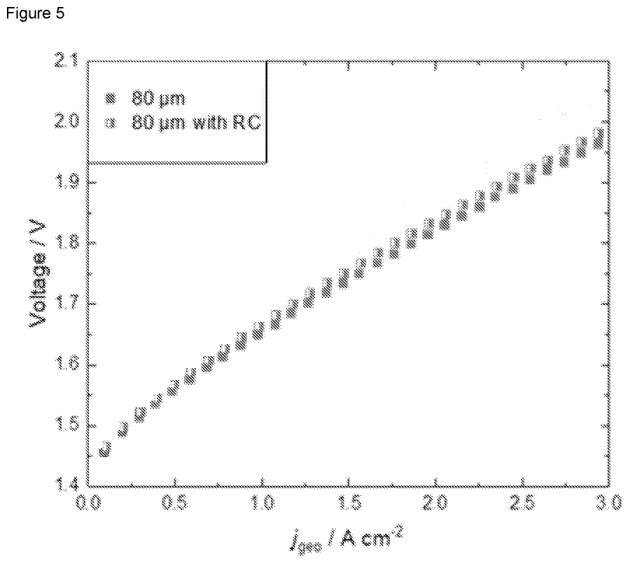

The results of testing of the 80 μm proton exchange membranes are shown in FIG. 5. The results indicate that the inclusion of a recombination catalyst layer as described herein does not have a detrimental impact on the performance of the membrane. The data indicates that the membranes provide CCMs with a particularly suitable balance of resistance and levels of hydrogen crossover enabling high pressure operation.

CCMs were also prepared incorporating 50-micron membranes with and without a recombination-catalyst containing membrane layer (with a Pt loading of 30 μg/cm²). The though-plane resistance of the CCMs was measured using electronic impedance spectroscopy (EIS) at 0.3 A cm⁻² which provided a value of 64-75μΩ/cm² for the CCM without the recombination-catalyst containing membrane layer and a value of 62-69 μΩ/cm² for the CCM without the recombination-catalyst containing membrane layer. These results indicate that a recombination catalyst can advantageously be introduced to a membrane as set out hereinbefore without detrimentally affecting resistance values.

1. An electrolyte membrane comprising a recombination catalyst layer, the membrane having a thickness of less than or equal to 100 mm, and wherein the recombination catalyst layer satisfies the following requirements:
(i) the layer comprises particles of an unsupported recombination catalyst dispersed in an ion conducting polymer;
(ii) the layer has a thickness in the range of and including 5 to 30 mm;
and the electrolyte membrane is a single coherent polymer film comprising a plurality of ion conducting polymer layers.

2. The electrolyte membrane according to claim 1, wherein the recombination catalyst is selected from one or more of platinum, palladium, and alloys or mixed oxides thereof.

3. The electrolyte membrane according to claim 1, wherein the particles of unsupported recombination catalyst have a particle size distribution such that the d90 is less than or equal to 3.0 mm.

4. The electrolyte membrane according to claim 1, wherein the particles of unsupported recombination catalyst have an average particle size greater than 0.1 mm.

5. The electrolyte membrane according to claim 1, wherein the membrane has a thickness in the range of and including 5 to 100 mm.

6. The electrolyte membrane according to claim 1, wherein the membrane comprises a reinforcement polymer, such as expanded polytetrafluoroethylene (ePTFE) or polybenzimidazole (PBI).

7. The electrolyte membrane according to claim 1 comprising a first ion conducting polymer layer and a second ion conducting polymer layer, and wherein the recombination catalyst layer is disposed between the first and the second ion conducting polymer layers.

8. The electrolyte membrane according to claim 7, wherein the membrane comprises a reinforcement polymer and wherein the reinforcement polymer is present in the first ion conducting polymer layer and/or the second ion conducting polymer layer.

9. The electrolyte membrane according to claim 7, wherein the first ion conducting polymer layer has a thickness in the range of and including 5 mm to 30 mm.

10. The electrolyte membrane according to claim 7, wherein the second ion conducting polymer layer has a thickness in the range 10 mm to 90 mm.

11. The electrolyte membrane according to claim 7, wherein the second ion conducting layer contains two regions of reinforcement polymer.

12. The electrolyte membrane according to claim 1, wherein the recombination catalyst layer has a thickness in the range of and including 5 to 15 mm.

13. A catalyst coated membrane for an electrochemical device, such as a water electrolyser, comprising the electrolyte membrane according to claim 1.

14. The catalyst coated membrane according to claim 13, wherein the electrolyte membrane comprises a first ion conducting polymer layer and a second ion conducting polymer layer with the recombination catalyst layer disposed between the first and second ion conducting polymer layers, and wherein an anode catalyst layer is disposed on a first face of the first ion conducting polymer layer, and the second face of the first ion conducting polymer layer faces in the direction of the recombination catalyst layer.

15. The catalyst coated membrane in accordance with claim 14, wherein the thickness of the first ion conducting layer is less than the thickness of the second ion conducting layer.

16. The catalyst coated membrane according to claim 13, wherein the electrolyte membrane comprises a first ion conducting polymer layer and a second ion conducting polymer layer with the recombination catalyst layer disposed between the first and second ion conducting polymer layers, and wherein a cathode catalyst layer is disposed on a first face of the second ion conducting polymer layer, and the second face of the second ion conducting polymer layer faces in the direction of the recombination catalyst layer.

17. The catalyst coated membrane according to claim 14, wherein the first ion conducting polymer layer has a thickness in the range of and including 5 mm to 30 mm.

18. The catalyst coated membrane according to claim 14, wherein the second ion conducting polymer layer has a thickness in the range of and including 10 mm to 90 mm.

19. A water electrolyser comprising the membrane according to claim 1.

20-24. (canceled)
